(19) United States
(12) Patent Application Publication
(10) Pub. No.: US 2013/0039048 A1
(43) Pub. Date: Feb. 14, 2013

(54) PORCELAIN ENAMEL ON LED LIGHTING DEVICE HOUSING

(71) Applicants: Chung W. Lo, Hong Kong (CN); Yuk Tsan Sy, Hong Kong (CN); Wa Hing Leung, Hong Kong (CN)

(72) Inventors: Chung W. Lo, Hong Kong (CN); Yuk Tsan Sy, Hong Kong (CN); Wa Hing Leung, Hong Kong (CN)

(21) Appl. No.: 13/559,231

(22) Filed: Jul. 26, 2012

Related U.S. Application Data
(60) Provisional application No. 61/523,070, filed on Aug. 12, 2011.

(51) Int. Cl. F21V 29/00; F21L 4/02; F21V 3/00; F21V 15/01

(52) U.S. Cl. 362/184; 362/249.02; 362/235

(57) ABSTRACT

An LED lighting device comprises: (a) a housing comprising: (i) a metal inner portion; and (ii) a porcelain enamel coating over at least a portion of an outer surface of the metal inner portion; and (b) at least one LED, the at least one LED being thermally coupled to the housing. The housing is configured to conduct heat from the at least one LED to the surrounding environment.

### CROSS-REFERENCE TO RELATED APPLICATIONS

This utility application claims benefit under 35 U.S.C. §119(e) of U.S. Provisional Patent Application No. 61/523,070, filed Aug. 12, 2011, the entirety of which is incorporated herein by reference.

### BACKGROUND OF THE INVENTION

The present invention generally relates to improved surface treatments, coatings and design of heat sinks/housings for light emitting diode (“LED”) lighting, i.e., lighting fixtures or devices, including but not limited to LED lamps, incorporating such coated heat sinks/housings.

LED lighting devices, such as LED lamps, produce a relatively high amount of heat during operation. To assist in dissipation of the heat produced, LED lighting devices are typically constructed with a metal housing that acts as a heat sink, dissipating the heat, by conducting it away from the LEDs, ultimately to the surrounding environment. To provide for good dissipation of heat, the heat sinks are typically made of metals with good heat conducting characteristics, such as aluminum, copper, and alloys thereof, or cast iron or steel.

While such metals perform excellently for conducting heat, constructing the LED lighting device with an exposed metal housing has some drawbacks. One such drawback is the increased likelihood that the user of the LED lighting device will suffer dangerous electrical shock when touching the housing, e.g., during installation or removal of the LED lighting device. Metals, as is well known, are very good electrical conductors and the likelihood of the occurrence of a dangerous conduction path from the power source to the user is increased with an increase in the usage of non-insulated exposed metal.

The use of a metal housing in LED lighting devices also makes it difficult for such lighting devices to pass the necessary safety tests, such as a “hi-pot” test. A hi-pot test (also referred to as a Dielectric Withstand test) verifies whether the insulation of a product or component sufficiently protects a user from electrical shock. The test typically involves applying a high voltage between a test product's current-carrying conductors and its metallic shielding, and allowing a hi-pot tester to monitor any current that flows or leaks through the insulation. If the high test voltage does not cause the insulation to break down, then the product can be deemed safe for the user under normal operating conditions. Because conventional heat sinks are made from metal, which is highly electrically conductive, ensuring that a conventional LED lighting device will pass a hi-pot test complicates the mechanical design and electrical design of LED lighting devices.

Another drawback is an aesthetic one. Bare metal housings may not be considered visually pleasing to users. Conventionally, options for providing a coating on a metal housing involve the application of powder coats, e-coats, or liquid paint. Powder coating of metal involves the application of a powder made up of small particles of plastic. Heat is used to melt and bond the plastic to the surface, forming a coating. Electrocoating is another method of applying a coat to metal. In this process, electrical current is used to apply paint to a metal surface, by oppositely charging the surface to be painted and the paint itself.

Another conventional coating technique is liquid painting, in which paint is sprayed onto a metal surface. This technique can be used in combination with the powder coating and electrocoating techniques discussed above.

However, while the techniques described above can apply, e.g., a coating of plastic to the metal, and achieve some level of electrical insulation and color, application of plastic coatings for this purpose have disadvantages of cost, thermal conduction efficiency, and require expensive equipment. Moreover, the above conventional coatings have relatively poor thermal conductivity, in the range of about 0.2 W/m·k. Also, typical powder coatings and liquid paint coatings have thicknesses in the range of less than 90 um and therefore do not exhibit optimal dielectric properties as insulators, increasing the risk of shock to users, and do not exhibit particularly good abrasion resistance and durability or color fastness.

Another conventional housing material in LED lighting devices is solid ceramic, instead of metal. However, while ceramics are good electrical insulators, a solid ceramic heat sink does not provide particularly good thermal conductivity, i.e., in the range of about 10-28 W/m·K, which is much less than metal. Thus, there exists a need for an LED lighting device housing/heat sink structure that provides high electrical insulation, high thermal conductivity, ease of manufacture and durability.

### BRIEF SUMMARY OF THE INVENTION

In accordance with one aspect of the present invention, an LED lighting device comprises: (a) a housing comprising: (i) a metal inner portion; and (ii) a porcelain enamel coating over at least a portion of an outer surface of the metal inner portion; and (b) at least one LED, the at least one LED being thermally coupled to the housing. The housing is configured to conduct heat from the at least one LED to the surrounding environment.

In another aspect, the LED lighting device further comprises: (c) a light transmissible surface coupled to the housing and configured to transmit light from the LED to outside the lighting device.

In another aspect, the LED lighting device further comprises a power supply unit electrically coupled to the at least one LED.

In another aspect, the power supply unit is integrally formed with the LED lighting device.

In another aspect, the power supply unit is separate from the LED lighting device and couples to supply electric power to the at least one LED via a wire.

In another aspect, the metal inner portion is made of materials selected from a group consisting of aluminum, copper, alloys of aluminum or copper, cast iron, and steel.

In another aspect, the LED lighting device further comprises a plate having a periphery, wherein the at least one LED is mounted on the plate and at least the periphery of the plate is thermally coupled to a portion of the housing.

In another aspect, the porcelain enamel coating is in a range of about 0.05 mm to 1 mm in thickness.

In another aspect, the dielectric strength of the porcelain enamel is in the range of 5000 to 13000 volts per mm.

In another aspect, the thermal conductivity of the porcelain enamel is in the range of about 4.2-12.6 W/m·K.

In another aspect, the light transmissible surface has a globe shape.

In another aspect, the light transmissible surface has a flat shape.

In another aspect, the light transmissible surface has a non-uniform shape so as to function as a light collimator.

In another aspect, the coating is over the entirety of the outer surface of the metal inner portion.

### BRIEF DESCRIPTION OF THE DRAWINGS

The figures are for illustration purposes only and are not necessarily drawn to scale. The invention itself, however, may best be understood by reference to the detailed description which follows when taken in conjunction with the accompanying drawings in which:

FIG. 1 is perspective view of an exemplary LED lighting device in accordance with an embodiment of the present invention;

FIG. 2 is a cross-sectional view of the housing portion of the LED lighting device shown in FIG. 1, showing the porcelain enamel coating on the housing;

FIG. 3 is a perspective view of an exemplary LED downlight in accordance with another embodiment of the present invention;

FIG. 4 is a cross-sectional view of the LED downlight shown in FIG. 3;

FIG. 5 is a magnified view of a portion of the view shown in FIG. 4;

FIG. 6 is a perspective view of another exemplary LED downlight in accordance with yet another embodiment of the present invention;

FIG. 7 is a cross-sectional view of the LED downlight shown in FIG. 6; and

FIG. 8 is a magnified view of a portion of the view shown in FIG. 7.

### DETAILED DESCRIPTION OF THE INVENTION

In order to overcome the difficulties of the prior art, in the embodiments of the present invention an LED lighting device is provided that has a housing having a heat dissipation function as well as a dielectric protection function. In accordance with advantageous aspects of the present invention, the housing has (i) a metal inner portion; and (ii) a porcelain enamel coating over at least a portion of the outer surface of the metal inner portion. The combination of the metal and the porcelain coating creates a heat sink having excellent heat dissipation as well highly as safe electrical insulation.

As discussed below, the use of the porcelain enamel process to coat the housing provides an LED housing/heat sink that exhibits very high electrical insulation and user safety, while at the same time allowing for excellent conduction of heat, with improved radiation of heat from the surface of the housing, while at the same time providing an extremely durable surface that is scratch resistant and color fast, even in the presence of UV light over long periods of time.

As porcelain enamel is an excellent electrical insulator, providing a housing/heat sink of an LED lighting device that comprises a metal inner portion with a porcelain enamel outer coating provides safety advantages over using a housing made of bare metal, or metal having a powder or paint coatings. In accordance with aspects of the present invention, it is particularly advantageous to provide, on the metal inner portion, a porcelain enamel coating in a thickness range of between about 0.05 mm to 1 mm, in order to provide, for the combined structure of metal and porcelain enamel, the optimal combination of electrical insulation and heat conduction. In the optimal range a high degree of safety would be achieved, producing hi-pot test results in the range of about 4 KV-10KV.

Although porcelain alone does not exhibit a particularly high degree of thermal conductivity, i.e., in the range of 4.2-12.6 W/m·K, porcelain enamel is a relatively good heat conductor when applied in a thin layer. Thus, in the present invention, porcelain enamels are preferably applied thinly, such that there is only a very small temperature gradient through them, allowing a housing/heat sink made from the combination of the metal and the porcelain enamel coating would provide the housing thus formed with good overall thermal conductivity. Making the housing from this combination of an inner metal portion and an outer layer of porcelain enamel also has advantageous effects with regard to the emissivity of the heat sink, affecting the amount of heat radiated from the heat sink.

In particular, for LED lighting applications, radiation typically accounts for 10% to 30% of overall heat dissipation. Emissivity (E), which is the effectiveness of the radiation effect, depends on the finishing and type of the particular surface. For example, for a shiny metallic surface E<0.1, while for a raw unpolished metal surface E=0.2−0.5, and for a painted surface E>0.85. The inherent E of porcelain enamel, such as the porcelain enamel coating utilized in the accordance with present invention, is >0.9, which makes it an ideal heat radiation surface, and allows it to contribute to heat transfer of the housing/heat sink in the radiation mode.

Thus, a housing/heat sink using the combination of a metal interior and a sufficiently thin outer porcelain coating provides the high heat conductivity from the metal component, together with the very high emissivity of the porcelain coating, which is highly conducive to heat transfer by radiation. This combination makes the heat dissipation characteristics of the combination structure superior to metal alone, which exhibits relatively low emissivity, and superior to ceramic or glass alone, which exhibits low heat conductivity by itself.

Also, importantly, the use of porcelain enamel as a coating on the housing/heat sink provides for significant advantages to the mechanical design of LED lighting devices as well as the design of the electric power source for the lighting device, for example, because concerns over safety and unwanted electrical conductivity are significantly reduced the more metal parts are coated with insulating porcelain enamel.

While the inert, impermeable qualities of glass make a porcelain enamel coating a good electrical insulator, the dielectric strength of a porcelain enamel coating will vary somewhat from point to point due to surface variations and internal bubble structure of the coating. The dielectric strength of ordinary porcelain enamels will range from 5000 to 13000 volts per mm with an average of 0.1 mm to 0.15 mm total thickness. Special “altered” porcelain enamel coatings with reduced bubble structure can be produced which have uniformly high voltage breakdown resistance. This alteration comprises changes in the frit composition of the glass and alterations in the microstructure of the coating to increase its dielectric strength. However, while the bubble structure of a porcelain enamel coating can be greatly reduced, it cannot be eliminated, even by this alteration process. The best dielectric strength is obtained with a minimum of three thin coats of the extremely dense altered porcelain enamel.

Moreover, the use of porcelain enamel in coating the housing/heat sink provides numerous additional advantages over the use of bare metal, or metal with a painted or powder coating, as it is smooth, hard, chemically resistant, durable, scratch resistant (5-6 on the Mohs scale). Additionally, the surface of the housing thus treated is a glass coating, and is thus clean and color fast even in the presence of UV light.

Unlike painted finishes, porcelain enamel can be restored to its original condition by washing with mild soap and water. After five, ten, or even twenty years, porcelain enamel retains its original color. The porcelain enamel layer resists scratching and retains its original luster even after years of hard use.

In preferred embodiments of the present invention, good adhesion with the metal inner structure is produced by reaction and fusion of the porcelain enamel coating with the base metal of the inner structure at relatively high temperatures. As a result, the porcelain enamel coating on the housing/heat sink in accordance with the present invention successfully resists harsh weather and work conditions, including extreme humidity, cold, and heat. Moreover, porcelain enamel does not deteriorate or corrode when in contact with chemicals found in most industries—it retains its original shape, color, and texture—ultimately providing years of extended use compared to other fixtures, which is essential to LED lighting devices, which typically have a 25,000 hours or longer lifespan.

The use of a housing/heat sink in accordance with the present invention will be illustrated by the embodiments shown in FIGS. 1-8. The embodiments are illustrative in nature and not limiting and the technique of the present invention can be used in any number of configurations of LED lighting device, as would be recognized by one skilled in the art.

FIG. 1 is a perspective view of an exemplary LED lighting device 10 employing the present invention. The LED lighting device 10 includes a globe portion 12, preferably made of glass, that forms the top portion of the LED lighting device 10. The glass globe portion 12 preferably performs, among other things, a light diffusing function, for example by being frosted or otherwise light diffusive.

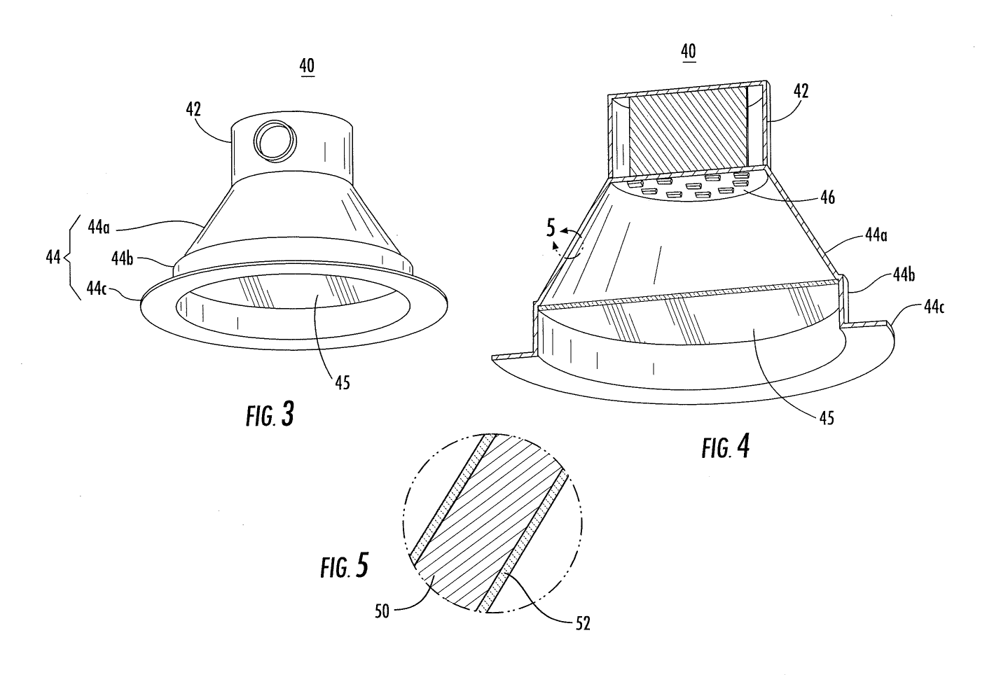

The LED lighting device 10 also includes LEDs 14, which emit light, a housing/heat sink 16, which, among other things, conducts the heat generated by the LEDs 14 out to the outside environment, and a lampbase 18, which would typically provide connectivity via a wall or ceiling socket for powering the LED lighting device 10. While lampbase 18 is shown in the figures as a threaded Edison, e.g., E26 or E27, the present invention is not limited to the disclosed embodiment and the lampbase 18 can be shaped in the form of a connector having any known configuration, for example, a double bayonet style mounting, a smooth shaped connector, etc., for connection to any of a number of known wall or ceiling sockets known in the art. As will be discussed further below, the coating technology of the present invention is not limited to LED light bulb applications. Such a coating is suitable for all indoor and outdoor LED lighting devices, such as, but not limited to, a downlight and street light. An example of an LED downlight will be discussed below with reference to FIGS. 3 and 4.

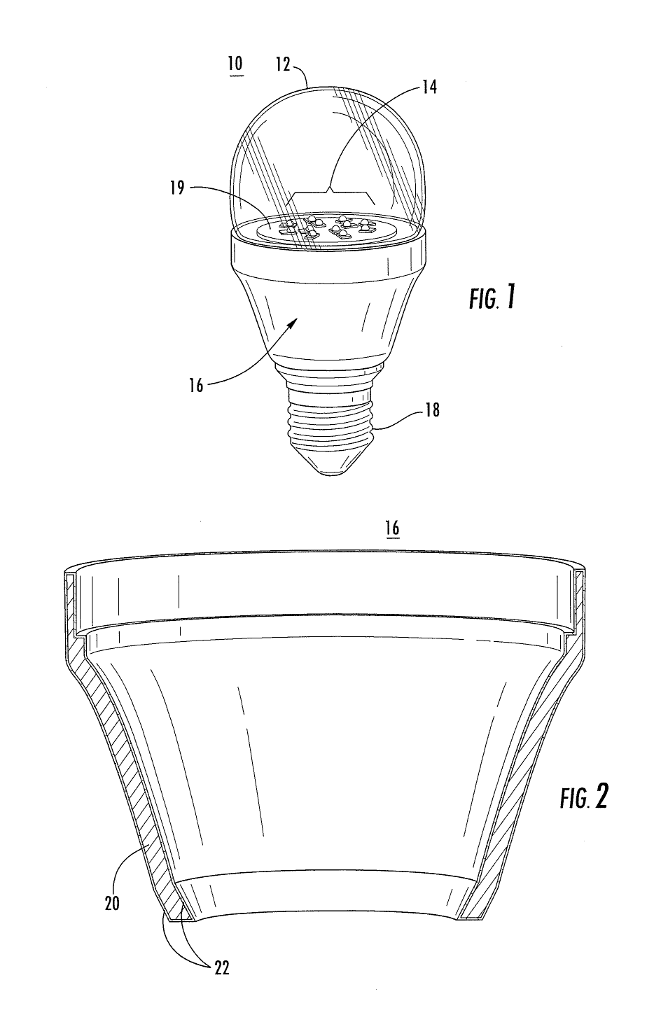

FIG. 2 is a cross-sectional view of the housing/heat sink 16 showing its structure in more detail in accordance with the present invention. Preferably, in accordance with the present invention, the housing/heat sink 16 has a metal inner structure 20, coated on its outer surface with a porcelain enamel 22. As shown in the figure, the porcelain enamel is preferably applied to all outer surfaces of the metal inner structure and preferably provides a substantially uniform coating of porcelain over the metal. However, in some situations it may be preferable to coat only a certain portion of the metal with the porcelain enamel. For example, it might be preferable to coat only the exposed outer surface that would be handled by a user.

The porcelain enamel is preferably applied in the known manner as a substantially vitreous or glassy inorganic coating bonded to the metal heat sink by fusion of powdered glass to the metal at a temperature above 800 degrees F.

In accordance with the present invention, the metal inner structure 20 of the housing/heat sink 16, is preferably made of a thermally conductive metal, such as, for example, aluminum, copper, and alloys thereof, or cast iron or steel.

In the illustrated embodiment, a thermally conducting plate 19, preferably made of metal or other thermally conductive material, is provided above the housing/heat sink 16 and rests in contact with a top annular rim of the housing/heat sink 16, or is thermally connected to the housing/heat sink 16.

The combination of the housing/heat sink 16 and the thermally conducting plate 19 allows for heat to be dissipated from the LEDs 14 to the outside environment.

Although not visible in the figures, as will be described below, electrical components, i.e., power circuitry, would typically be provided within the housing/heat sink 16 and connected to PCB circuitry that supplies power and control to the LEDs 14, in any known manner.

The LEDs 14 may be any of the known types of LEDs, including but not limited to single colored LEDs or multiple-colored LEDs. Further, one or more LED chips can be included in a package and mounted to PCB circuitry.

While the LED lighting device shown in FIGS. 1 and 2 is in the form of a light bulb, the present invention is not limited to LED light bulbs. The present invention may be used in any LED lighting device configuration having a housing/heat sink that functions to conduct heat from the LEDs. For example, while the illustrated LED lighting device is shown as having a rounded profile, the invention is not limited to this shape. The shape of the LED lighting device can be of any appropriate shape for LED lighting devices, including but not limited to tubular, cylindrical or rectangular, and having housings/heat sinks of various shapes and configurations. Moreover, while the globe has been described in the preferred configuration as being made of glass, the invention is not limited to using glass. Other materials appropriate for use in light bulbs, such as plastics, could be used as well.

For example, another type of LED lighting fixture that embodies the present invention is shown in FIGS. 3-5, which show an LED downlight 40. The LED downlight 40 has a power supply unit (PSU) 42, which supplies electric power to the downlight 40. The power supply is, in the illustrated embodiment, affixed to a heat sink 44 that includes frustoconical portion 44a, vertical portion 44b, and rim 44c. A light transmissible surface is provided to transmit light out of the LED downlight. In the illustrated embodiment, the light transmissible surface comprises an optical diffuser plate 45, which functions to diffuse the light from the LEDs 46, which can be seen in the cross-sectional view of FIG. 4.

FIG. 4 is a cross-sectional view of the LED downlight 40 which shows the LEDs 46 mounted on a PCB and connected to the PSU 42. The PSU 42 delivers electrical power to the LEDs 46 in any known manner, for example, from a ceiling outlet, a battery unit, or other known source of electrical power for lighting. The PSU 42 may be integral with the LED downlight 40, as shown in FIGS. 4 and 5, but also may be a separate PSU, for example, in a separate box containing all the PSU components, connected to the LED downlight via a cable.

As can be seen clearly in the magnified image in FIG. 5, at least elements 44a and 44b of the heat sink 44 comprise an inner metal structure 50, with a porcelain enamel coating 52. Optionally, element 44c also has this same coated structure. The porcelain enamel coating 52 has been described in detail above and in connection with FIGS. 1 and 2, and is identical to the coating 22 in FIG. 2 in structure and function. The porcelain enamel coating 52 provides the same features and advantages in the LED downlight 40 as in the bulb shaped LED lighting device 10 shown in FIGS. 1 and 2 and described above in detail, which is not repeated here.

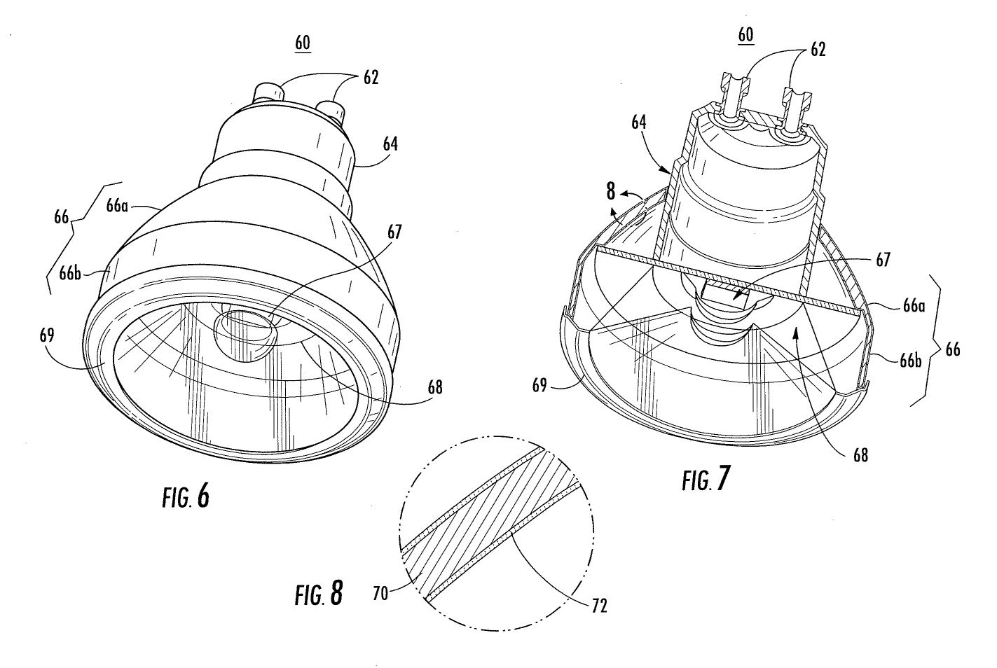

Yet another exemplary another type of LED lighting product that can utilize the coating of the present invention is shown in FIGS. 6-7, which show an LED lighting device 60. The LED lighting device 60 has a power supply housing 64, which supplies electric power to the LED lighting device 60. In the illustrated embodiment, the power supply housing has two pins 62 for a twist and lock connection. However, the invention is not limited to the illustrated type of connector and can utilized any appropriate connector to connect with, e.g., a wall or ceiling socket. The power supply housing 64 is, in the illustrated embodiment, coupled to a heat sink 66 that includes frustoconical portion 66a, and vertical portion 66b.

A light transmissible surface is provided to transmit light out of the LED lighting device 60. In this illustrated embodiment, the light transmissible surface comprises an optical lens 68, which has a non-uniform shape so as to functions serve as a light collimator for the light from the LEDs 67. The bottom edge of the LED lighting device 60 is provided with an annular rim 69, which provides mechanical support and protection for the bottom of the LED lighting device 60. The rim 69 can be made of metal, plastic, or other material that would provide the protective and support function and can be mated with the housing and optical lens 68 in any appropriate manner, e.g., snap fit, screw fit, etc.

FIG. 7 is a cross-sectional view of the LED lighting device 60 which shows the LEDs 67 coupled to the power supply housing 64. The power supply housing 64 delivers electrical power to the LEDs 67 in any known manner, for example, from a ceiling outlet, a battery unit, or other known source of electrical power for lighting. The power supply housing 64 may be integral with the LED lighting device 60, as shown in FIGS. 6 and 7, but also may be a separate power supply housing, for example, a separate box, connected to the LED lighting device 60 via a cable, as discussed above with regard to the embodiment of FIGS. 3-5.

As can be seen clearly in the magnified image in FIG. 8, the housing 66, consisting of elements 66a and 66b, comprises an inner metal structure 70, with a porcelain enamel coating 72. The porcelain enamel coating 72 has been described in detail above in connection with FIGS. 1 and 2, and FIGS. 3-5, and is identical to the coating 22 in FIG. 2, and the coating 52 in FIG. 5 in structure and function. The porcelain enamel coating 72 provides the same features and advantages in the LED lighting device 60 as in the bulb shaped LED lighting device 10 shown in FIGS. 1 and 2 and the LED downlight 40 shown in FIGS. 3-5, and described above in detail, which is not repeated here.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, although a bulb shaped lighting device, and a downlight have been illustrated, the present invention can be applied to the construction of the heatsink of any configuration of an LED lighting fixture. In each configuration, the same porcelain enamel coating process would be applied to the metal heatsink portion in the same manner described above to provide the advantages discussed above, as would be understood by one of skill in the art. This provisional application is intended to cover any adaptations or variations of the specific embodiments discussed herein. Therefore, it is intended that this invention be limited only by the claims and the equivalents thereof.

What is claimed is:

1. An LED lighting device, comprising:
(a) a housing comprising:
(i) a metal inner portion; and
(ii) a porcelain enamel coating over at least a portion of an outer surface of the metal inner portion; and
(b) at least one LED, the at least one LED being thermally coupled to the housing,
the housing being configured to conduct heat from the at least one LED to the surrounding environment.

2. The LED lighting device according to claim 1, further comprising:
(c) a light transmissible surface coupled to the housing and configured to transmit light from the LED to outside the lighting device.

3. The LED lighting device according to claim 1, further comprising a power supply unit electrically coupled to the at least one LED.

4. The LED lighting device according to claim 3, wherein the power supply unit is integrally formed with the LED lighting device.

5. The LED lighting device according to claim 3, wherein the power supply unit is separate from the LED lighting device and couples to supply electric power to the at least one LED via a wire.

6. The LED lighting device according to claim 1, wherein the metal inner portion is made of materials selected from a group consisting of aluminum, copper, alloys of aluminum or copper, cast iron, and steel.

7. The LED lighting device according to claim 1, further comprising a plate having a periphery, wherein the at least one LED is mounted on the plate and at least the periphery of the plate is thermally coupled to a portion of the housing.

8. The LED lighting device according to claim 1, wherein the porcelain enamel coating is in a range of about 0.05 mm to 1 mm in thickness.

9. The LED lighting device according to claim 1, wherein the dielectric strength of the porcelain enamel is in the range of 5000 to 13000 volts per mm.

10. The LED lighting device according to claim 1, wherein the thermal conductivity of the porcelain enamel is in the range of about 4.2-12.6 W/m·K.

11. The LED lighting device according to claim 2, wherein the light transmissible surface has a globe shape.

12. The LED lighting device according to claim 2, wherein the light transmissible surface has a flat shape.

13. The LED lighting device according to claim 2, wherein the light transmissible surface has a non-uniform shape so as to function as a light collimator.

14. The LED lighting device according to claim 1, wherein the coating is over the entirety of the outer surface of the metal inner portion.
